(19) United States
(12) Patent Application Publication
(10) Pub. No.: US 2026/0070607 A1
(43) Pub. Date: Mar. 12, 2026

(54) ELECTROMECHANICAL STEERING SYSTEM AND METHOD FOR OPERATING AN ELECTROMECHANICAL STEERING SYSTEM WITH REDUCED ENERGY FEEDBACK

(71) Applicants: thyssenkrupp Presta AG, Eschen (LI); thyssenkrupp AG, Essen (DE)

(72) Inventors: Tamás Gergely KÁROLY, Sennwald (CH); Jenoe GYOEKERES, Budapest (HU)

(73) Assignees: thyssenkrupp Presta AG, Eschen (LI); thyssenkrupp AG, Essen (DE)

(21) Appl. No.: 19/325,357

(22) Filed: Sep. 10, 2025

(30) Foreign Application Priority Data
Sep. 11, 2024 (BE) BE 2024/5612

(51) Int. Cl. B62D 5/04

(52) U.S. Cl. CPC B62D 5/0481; B62D 5/0403; B62D 5/0409; B62D 5/0421

(57) ABSTRACT

A method for operating an electromechanical steering system in a motor vehicle, wherein the steering system comprises at least one actuator having at least one electric motor, wherein the at least one electric motor is connected via a DC bus to an electrical on-board power supply system of the motor vehicle, comprises operating the at least one electric motor in a motor mode or a generator mode depending on the driving situation. At least one control unit of the steering system monitors an actual voltage level of the DC bus with respect to an exceedance of a target voltage level of the DC bus by a predetermined value, wherein, in the case of a detected exceedance by a first predetermined value, the actual voltage level is reduced by converting electrical energy in at least one of the electric motors. An electromechanical steering system is designed to be operated according to such a method.

### CROSS REFERENCE TO RELATED APPLICATION

This application is a U.S. Non-Provisional that claims priority to Belgian Patent Application No. BE 2024/5612, filed Sep. 11, 2024, the entire content of which is incorporated herein by reference.

### FIELD

The present disclosure relates to a method for operating an electromechanical steering system in a motor vehicle.

### BACKGROUND

In the prior art, such a method for a steer-by-wire steering system as an electromechanical steering system and a steer-by-wire steering system having a feedback actuator as the first actuator and a steering actuator as the second actuator are known, for example, from EP 4 273 025 A1.

A DC bus in a motor vehicle, in particular in electric vehicles, plays a central role in the distribution and management of electrical energy within the motor vehicle. The DC bus is an electrical line that provides direct current (DC) from the vehicle battery to various electrical consumers in the motor vehicle, in particular also the actuators of a steering system, more particularly a steering actuator and/or a feedback actuator of a steering system. Depending on the power requirements of the respective electrical consumers that are connected to the DC bus, the DC bus may also include DC/DC converters in order to be able to provide different voltage levels. In order for the electrical consumers that are connected to the DC bus to operate correctly, it is necessary for the voltage provided to remain substantially constant.

In particular, if an electric motor that is connected to the DC bus is operated in a generator mode, there is the problem that electric currents are generated because the DC voltage source providing the operating voltage for the DC bus and/or a connection to the DC voltage source, in particular a DC/DC converter, is not suitable or, in the case of newer vehicles that do not include only a classic starter battery (car battery), is no longer suitable for the reception of such generated currents for cost reasons, amongst others. In particular, the electric motors of a steering system, more particularly the electric motor of a feedback actuator of a steering system, are also operated in a normal mode of the steering system in a generator mode. The currents generated in this case can therefore potentially cause damage to electronics components. Conventional vehicle batteries, which are used, in particular, in motor vehicles comprising only an internal combustion engine, are thus often suitable for receiving such generated currents. However, newer designs of on-board power supply systems with a higher on-board power supply system voltage and the provision of the operating voltage via a drive battery in hybrid or electric vehicles using a DC bus are not routinely designed to receive or feed back generated currents. This problem is also addressed in DE 10 2021 205 851 A1, wherein, in this document, it is proposed to switch on unnecessary consumers if feedback would cause an overvoltage in the on-board power supply system.

Thus a need exists to provide an improved method for operating an electromechanical steering system and an improved electromechanical steering system. In particular, the intention is to prevent damage being caused by the generated electric currents in a generator mode of an electric motor of an actuator of the steering system.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a simplified perspective illustration of an exemplary embodiment of an electromechanical steering system designed according to the invention.

FIG. 2 shows a block diagram, depicted in simplified fashion, for explaining an exemplary embodiment of a method for operating an electromechanical steering system, which is designed according to the invention.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

The present disclosure relates to a method for operating an electromechanical steering system in a motor vehicle, wherein the steering system comprises at least one actuator having at least one electric motor, wherein the at least one electric motor is connected via a DC bus, also referred to as DC voltage bus, to an electrical on-board power supply system of the motor vehicle, and wherein the at least one electric motor is operated in a motor mode or a generator mode depending on the driving situation. The invention also relates to an electromechanical steering system, which comprises at least one actuator having at least one electric motor and having at least one control unit, wherein the at least one electric motor can be operated in a motor mode or a generator mode depending on the driving situation. In particular, the steering system comprises, in particular, a steering actuator or a steering actuator and a feedback actuator as actuators.

Against this background, a need exists to provide an improved method for operating an electromechanical steering system and an improved electromechanical steering system. In particular, the intention is to prevent currents that lead to critical overvoltages from being returned to the DC bus that supplies energy to the actuators of the steering system.

The proposed solution provides a method for operating an electromechanical steering system, in particular a steer-by-wire steering system, in a motor vehicle, wherein the steering system comprises at least one actuator having at least one electric motor, wherein the at least one electric motor is connected via a DC bus to an electrical on-board power supply system of the motor vehicle, and wherein the at least one electric motor is operated in a motor mode or a generator mode depending on the driving situation. Provision is also made for at least one control unit of the steering system to monitor an actual voltage level of the DC bus with respect to an exceedance of a target voltage level of the DC bus by a predetermined value. In the case of a detected exceedance of the target voltage level by a first predetermined value, the actual voltage level is then reduced by converting electrical energy in at least one of the electric motors. Currents that are generated by the actuators that are connected to the DC bus can thus advantageously be converted energetically in the at least one electric motor of the steering system. In particular, the phase resistance of the at least one electric motor of the steering system is used to compensate for a regenerative direct current in the DC bus.

The at least one electric motor is designed, in particular, as a three-phase motor, more particularly as a permanent-magnet synchronous motor. By converting the current directly in an electric motor of the steering system, damage that is caused by the currents fed into the DC bus is advantageously largely avoided. The conversion advantageously remains largely unnoticed by a vehicle user and more advantageously has no negative effects on the steering behaviour of the motor vehicle and no negative effects on the steering feeling for the vehicle user. The voltage level on the DC bus may be, in particular, 12 V or 48 V (V: volts). Other voltage levels, in particular even greater than 48 V, may also be provided.

In particular, provision is made for the steering system to have a steering actuator having an electric motor as an actuator. The steering actuator is advantageously designed to convert a detected steering specification into a wheel steering angle of steered wheels. In addition, provision may be made, particularly when the steering system is a steer-by-wire steering system, for the steering system to have, as an additional actuator, a feedback actuator having an electric motor, wherein the feedback actuator is designed, in particular, to act on a steering handle via a steering shaft. The electric motor of the steering actuator and/or the electric motor of the feedback actuator may each be of redundant design. In particular, in a normal mode of the steering system by way of these electric motors, in particular through the operation of the electric motor of the feedback actuator, the result is the generation of electric currents, which may cause the above-described exceedance of the target voltage level of the DC bus by a predetermined value. However, these currents are advantageously “consumed”, that is to say energetically converted, directly by the at least one electric motor of the steering system. Advantageously, however, generated currents can be converted energetically in the at least one electric motor of the steering system, in particular also by additional actuators that are connected to the DC bus, said actuators, in particular, not being part of the steering system.

According to one advantageous development of the method, different actuations of the at least one electric motor that are associated with the respective actual voltage levels are advantageously carried out for different actual voltage levels that exceed the target voltage level. In particular, different measures are defined for the way in which the electrical energy is converted in the at least one electric motor. Provision is thus made, in particular, for the steering system to comprise multiple electric motors, wherein a specific electric motor of the steering system is advantageously actuated depending on the extent of the deviation between the actual voltage level and the target voltage level for the energetic conversion of the generated currents, in particular on the one hand such that the target voltage level is kept as constant as possible and on the other hand so that the steering behaviour that is perceptible by a vehicle user and the steering feeling that is perceptible by a vehicle user are not adversely affected.

Another advantageous embodiment makes provision, in the event of a detected exceedance of the target voltage level up to a second value, wherein the second value is lower than the first value, for a DC bus control unit associated with the DC bus to control a reduction of the actual voltage level. Use is advantageously made of the fact that the DC bus is routinely designed so that it is able, to a small extent, to absorb exceedances of the target voltage level, in particular when generated currents are smaller than 10 A (A: amperes). Advantageously, in the case of smaller exceedances of the target voltage level, it is possible to refrain from actuation of the at least one electric motor of the steering system for the energetic conversion of these currents.

Provision is more advantageously made for the DC bus to be of redundant design and to have a DC A-side and a DC B-side, wherein the DC B-side takes over a voltage supply in the event of a failure of the DC A-side, wherein tolerances regarding a deviation between the actual voltage level and the target voltage level in relation to the DC A-side are lower than in relation to the DC B-side, and wherein different predetermined values for triggering the conversion of electrical energy in the at least one electric motor are defined for deviations between the actual voltage level and the target voltage level for the DC A-side and the DC B-side. In particular, the DC A-side, in particular a control unit assigned to the DC A-side, controls a reduction of the actual voltage level due to generated currents, in particular currents that are generated by the electric motor of the feedback actuator, more particularly generated currents up to a maximum of 10 A. A distinction is thus advantageously made between a normal mode and a special mode, wherein, in the case of normal mode, a supply voltage is provided via the DC A-side and wherein, in the case of a normal mode, damage to electrical customers connected to the DC bus should be avoided, and wherein, in the case of the special mode, at least one basic functionality of the motor vehicle is kept in the foreground.

According to another particularly advantageous embodiment, the steering system comprises a plurality of actuators, wherein each actuator is assigned a respective control unit. Each of these control units advantageously monitors the actual voltage level of the DC bus with respect to an exceedance of the target voltage level of the DC bus by the predetermined value, wherein, in particular, a different deviation between the actual voltage level and the target voltage level is specified for each of the control units, which triggers an actuation to reduce the actual voltage level in particular an actuation to bring the actual voltage level closer to the target voltage level. The actual voltage level is advantageously recorded in real time. More advantageously, the detection of the actual voltage level between the control units is synchronized, wherein the DC bus is advantageously used as an indirect communication channel. In particular, the applied DC voltage itself is used as a “communication channel”, since it is measured in real time by all relevant control units (ECU: electronic control unit) in the DC bus. A direct private CAN communication (CAN: computer area network) is thus advantageously not required to enable the control units to interact. Each control unit of an actuator unit therefore advantageously monitors only exactly one exceedance of an actual voltage value specifically specified for the respective control unit, and triggers a control command specified for the respective control unit in the case of an exceedance. The method is in this way advantageously less prone to errors and very robust.

The at least one electric motor of the steering system is preferably controlled by a control unit, in particular in each case one control unit, by means of vector control, wherein a d-vector having an associated current I_d and a q-vector having an associated current I_q of a rotor-referred d/q system for the at least one electric motor are influenced by means of a first controller, in particular, a PI controller, of the control unit. The d-vector of the rotor-referred d/q system and thus the current I_d for the first electric motor is advantageously adapted for the energetic conversion of a generated current that is applied to the DC bus.

For such vector control, a mathematical conversion by means of a Clarke transformation and a subsequent Park transformation from a stator-referred three-phase system to the rotor-referred d/q system, in particular, is carried out in a known manner, wherein the d-vector and the q-vector are aligned orthogonally with respect to one another. As is customary in vector control, the q-vector is used to set a torque to be provided, with the d-vector influencing the magnetic flux density.

The d-vector of the rotor-referred d/q-system for an electric motor of the steering system is thus adapted, in particular increased, for the energetic conversion and reduction of an actual voltage level that exceeds the target voltage level. The d-vector is advantageously adapted in such a way that the actual voltage level is decreased again to the target voltage level and, in particular, a generated current that is applied to the DC bus is converted completely or at least almost completely in the electric motor of the steering system. The d-vector and thus the I_d current are adapted, in particular, by means of the controller used for vector control. The q-vector and thus the I_q current advantageously remain unaffected, such that a torque that is perceptible for a vehicle user during operation of the steering system is not generated by the conversion of the generated currents applied to the DC bus.

The steering system preferably comprises, as the at least one actuator having the at least one electric motor, a feedback actuator acting via a steering shaft on a steering handle and having a first electric motor and a steering actuator acting via a steering gear on steerable wheels of the motor vehicle and having a second electric motor. In particular, the second electric motor of the steering actuator is actuated to convert generated energy, which increases the actual voltage level above the target voltage level. In the case of the detected exceedance by at least the predetermined first value, the actual voltage level is thus advantageously reduced by converting electrical energy in the second electric motor. In particular, this embodiment makes use of the fact that an electric motor of a steering actuator is operated predominantly in a motor mode during operation of a motor vehicle and is hardly operated in a generator mode, whereas an electric motor of a feedback actuator is often operated in a generator mode. Avoiding a conversion of electrical energy in the first electric motor of the feedback actuator can also advantageously keep a ripple in the first electric motor low, as a result of which adverse effects on the steering feeling for a driver are advantageously avoided or at least kept low.

Provision is further advantageously made for the second electric motor of the steering actuator to be of redundant design and to have a separately actuatable A-side and a separately actuatable B-side, wherein, in the case of the detected exceedance by at least the predetermined first value, the actual voltage level is reduced by converting electrical energy on the A-side of the second electric motor. According to one advantageous development, in the case of the detected exceedance by at least a predetermined third value, wherein the third value is greater than the first value, the actual voltage level is reduced or further reduced by converting electrical energy on the B-side of the second electric motor. Such a cascaded chain of measures is advantageously defined in order to return an actual voltage level that has significantly exceeded the target voltage level back to the target voltage level. In particular, provision is made for the A-side and the B-side to be able to be regarded as two completely separate systems, in which the A-side is supplied with voltage via the DC A-side and the B-side is supplied with voltage via the DC B-side.

Provision is made, as another advantageous development, in the case of a detected exceedance by at least a predetermined second value, wherein the second value is greater than the first value, for the actual voltage level to be reduced by additionally converting electrical energy in the second electric motor, that is to say the electric motor of the feedback actuator. By way of these additional measures, in particular the different actuation of the A-side and B-side of the electric motor of the steering actuator and/or the actuation of the first electric motor of the feedback actuator, it is advantageously possible to prevent restrictions in a damping torque to be provided by the electric motor of the steering actuator. In particular, provision is thus made for first the A-side of the electric motor of the steering actuator, then the electric motor of the feedback actuator and then the B-side of the electric motor of the steering actuator to be actuated for the conversion of excess electrical energy when the actual voltage level exceeds the target voltage level.

To solve the object mentioned at the beginning, an electromechanical steering system, in particular a steer-by-wire steering system, is also proposed, which comprises at least one actuator having at least one electric motor and having at least one control unit, wherein the at least one electric motor can be operated in a motor mode or a generator mode depending on the driving situation. The steering system is designed to be operated according to a method designed according to the invention. The features and advantages explained in connection with the method described also apply accordingly to the proposed steering system.

One advantageous embodiment of the steering system makes provision for the steering system to comprise, as a first actuator, a feedback actuator acting via a steering shaft on a steering handle and, as a second actuator, a steering actuator acting via a steering gear on steerable wheels of the motor vehicle. A first electric motor is in this case an electric motor of the feedback actuator, to which a first control unit is assigned, and a second electric motor is an electric motor of the steering actuator, to which a second control unit is assigned, wherein the first control unit and the second control unit may be, in particular, a control unit comprised by a powerpack of the respective electric motor. In particular, the embodiment of the steering system makes use of the fact that an electric motor of a steering actuator is operated predominantly in a motor mode during operation of a motor vehicle and is hardly operated in a generator mode, whereas an electric motor of a feedback actuator is often operated in generator mode. The additional ripple in the first electric motor and thus in the feedback actuator advantageously cannot be felt by a driver when operating the steering system in a motor vehicle. This means that the steering feeling will advantageously not change.

The first electric motor and the second electric motor are each designed, in particular, as a three-phase motor, more particularly as a permanent-magnet synchronous motor in each case. The first control unit and the second control unit are advantageously directly assigned to the respective electric motor. However, the first control unit and the second control unit may be, in particular, comprised by a higher-level control unit. The first electric motor and the second electric motor are advantageously controlled by means of vector control, wherein each of the electric motors is advantageously assigned a corresponding controller, in particular a PI controller.

The PI controller advantageously has a reference input that is dependent on the rotational speed of the respective electric motor in the event that the first electric motor is operating in a generator mode. A current that is actually provided in the DC bus for the supply of energy to the electric motors of the steering system is advantageously calculated from the d-q voltage outputs of the PI controller and from the information relating to the d-q currents. The PI controller is advantageously designed the Id current that is required to reduce the current that is generated regeneratively in the DC bus by an electric motor in generator mode. This Id current is advantageously added to the Id reference output of the second control system of the second electric motor. The second electric motor is then operated with the sum Id_ref, and thus the currents that are generated in generator mode are energetically converted, advantageously almost without influence on the torque to be provided by the electric motor.

In the various figures, identical parts are generally provided with the same reference signs and are therefore also, in some cases, each explained only in conjunction with one of the figures.

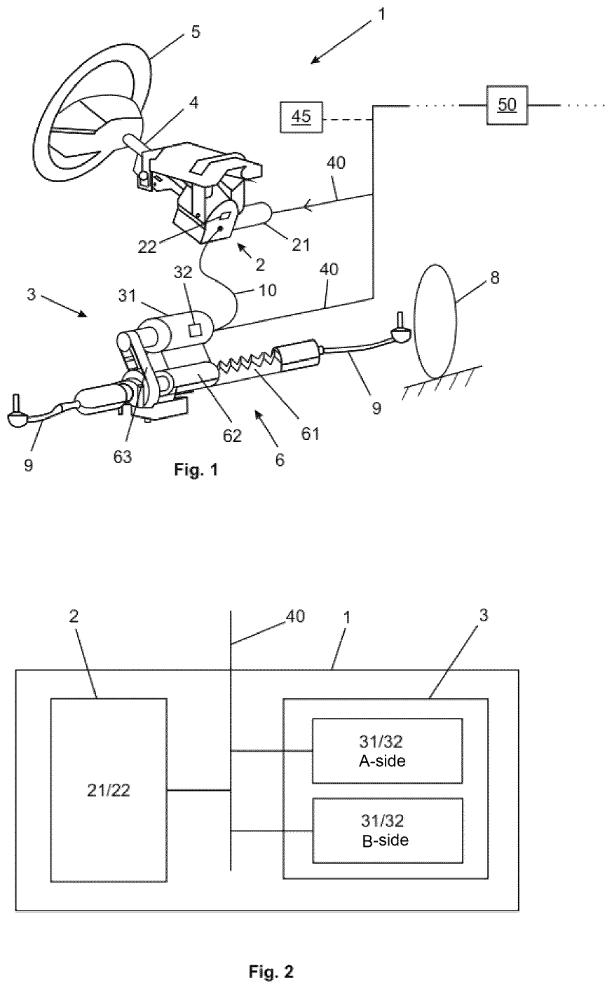

FIG. 1 depicts in a simplified manner an exemplary embodiment of an electromechanical steering system 1 which is designed according to the invention and is designed as a steer-by-wire steering system in this exemplary embodiment. In this exemplary embodiment, the steering system 1 comprises a first actuator 2 having a first electric motor 21 and having a first control unit 22. The steering system 1 also comprises a second actuator 3 having a second electric motor 31 and having a second control unit 32. The first actuator 2 is a feedback actuator acting via a steering shaft 4 of the steering system 1 on a steering handle 5 connected to the steering shaft 4 in a rotationally fixed manner and the first electric motor 21 is accordingly a feedback actuator electric motor. The second actuator 3 of the steering system 1 is a steering actuator acting via a steering gear 6 on steerable wheels 8 of the motor vehicle and the second electric motor 31 is accordingly a steering actuator electric motor. Both electric motors 21, 31 are three-phase motors, in particular permanent-magnet synchronous motors.

The first electric motor 21 is operated in a motor mode depending on the driving situation, in particular for generating an active counter-steering action against a steering input applied by a driver to the steering handle 5, or operated in a generator mode, in particular when a certain steering resistance is displayed towards a steering movement applied by a driver. The first actuator 2 having the first electric motor 21 is thus designed, in particular, to exert a torque or a steering resistance torque on the steering shaft 4, in particular for conveying a steering feeling that is perceptible for a driver of a motor vehicle.

The second electric motor 31 can also be operated in principle in a motor mode and a generator mode, wherein a generator mode in relation to the second electric motor 31 arises relatively rarely, for example when a different wheel steering angle is forced on the steerable wheels 8 from the outside due to an obstacle. A motor mode of the second electric motor 31 is required in this case particularly when a detected steering specification, in particular a steering movement applied by a driver via the steering handle 5, must be converted to a corresponding wheel steering angle of the steered wheels 8. In order to convert a steering specification to a wheel steering angle of the steerable wheels 8, the second actuator 3 acts via the steering gear 6 on the steerable wheels 8.

Specifically, in this exemplary embodiment, provision is made for the second electric motor 31 of the second actuator 3 to act via a transmission belt 63 on a spindle drive 62, which is operatively connected to a coupling rod 61 formed as a rack. Appropriate actuation of the second electric motor 31 drives the spindle drive 62 for converting a steering specification to a steering movement of the steerable wheels 8. In this case, the second actuator acts via the spindle drive 62, which is driven by the second electric motor 31, on the coupling rod 61 and thus triggers a steering movement of the steerable wheels 8 of a motor vehicle, wherein the steerable wheels 8 in this exemplary embodiment are connected in a known manner to the coupling rod 61 via track rods 9. The track rods 9 themselves are each connected to one steered wheel 8 in a known manner via steering knuckles.

The first electric motor 21 and the second electric motor 31 of the steering system 1 are connected via a DC bus 40 to an electrical on-board power supply system of the motor vehicle, wherein further electrical consumers (not explicitly shown in FIG. 1) are connected to the DC bus 40, in particular also via a DC/DC converter 50 of the DC bus 40. The energy required for a motor mode of the electric motors 21, 31 is provided here via the DC bus 40.

The first electric motor 21 and the second electric motor 31 are respectively actuated based on vector control by means of the control units 22, 32 assigned to the electric motors 21, 31. For this purpose, the stator-referred three-phase system is transformed in a known manner to a rotor-referred d/q system, which is carried out using a Clarke transformation with subsequent Park transformation. The d-vector and q-vector thus obtained for the control of the respective electric motor 21, 31 are then adapted accordingly by means of a PI controller included in the respective control unit 22, 32 in order to implement a control specification. As usual, the torque to be provided by the respective electric motor 21, 32 is controlled by an adjustment of the q-value, while the d-value has an influence on the magnetic flux density.

The first electric motor 21 and the second electric motor 31 are operated in a motor mode or a generator mode depending on the driving situation, wherein usually a generator mode of the second electric motor 31 rarely occurs. During operation of the motor vehicle, the first control unit 22 and the second control unit 32 of the steering system 1 monitor whether an actual voltage level of the DC bus 40 exceeds a target voltage level of the DC bus 40 by a predetermined value. In this exemplary embodiment, to reduce the actual voltage level to the target voltage level, provision is furthermore made for electrical energy to be converted in the second electric motor 31 when the second control unit 32 has identified that the actual voltage level of the DC bus 40 has exceeded the target voltage level of the DC bus 40 by a predetermined first value.

Such an exceedance of the target voltage level in the DC bus 40 can occur, in particular, when the first electric motor 21 is operated in a generator mode. The second control unit 32 then controls the second electric motor 31 by means of a PI controller included in the second control unit 32 in such a way that a current that is generated in generator mode of the first electric motor 21 is converted energetically by the second electric motor 31.

If the first electric motor 21 is now operated in a generator mode so that the actual voltage level exceeds the target voltage level by the predetermined first value, the second electric motor 31 is actuated by the PI controller of the second control unit 32 in such a way that a I_d current that is specified for the second electric motor 31 as part of vector control is adapted, in particular is increased, which is done by appropriately adapting the d-vector. The current that is generated in generator mode of the first electric motor 21, which has led to an undesirable increase in the actual voltage level, is hereby converted energetically by the second electric motor 31. As a result of the fact that only the d-vector, but not the q-vector, is adapted, the adapted current I_d advantageously has no influence on the behaviour of the steering system 1 that is perceived by a vehicle user during steering. The current that is generated by the first electric motor 21 is thus advantageously “combusted” in the second electric motor 31 and thus advantageously does not load the DC bus 40 and not further electronics components connected to the DC bus 40. In particular, provision is made for different values to be specified, wherein the value by which the actual voltage level at least exceeds the target voltage level is monitored.

One advantageous embodiment of a method for operating an electromechanical steering system 1 in a motor vehicle, in particular the steer-by-wire steering system 1 shown in FIG. 1, is explained in more detail with reference to the block diagram shown in FIG. 2.

Provision is again made for the steering system 1 to be a steer-by-wire steering system, which comprises, as a first actuator 2, a feedback actuator acting via a steering shaft on a steering handle and having a first electric motor 21 and, as a second actuator 3, a steering actuator acting via a steering gear on steerable wheels of the motor vehicle and having a second electric motor 31. The second electric motor 31 of the steering actuator is of redundant design, with a separately actuatable A-side and a separately actuatable B-side. The A-side and B-side can be formed either as independent electric motors, so that the second electric motor 31 actually comprises two electric motors (A-side and B-side) or can be formed as separately actuatable winding groups (A-side and B-side) of the second electric motor 31. The first electric motor 21 and the second electric motor 31 are each assigned a control unit 22, 32. The respective electric motor 21, 31, in particular the A-side and the B-side of the respective electric motor 21, 31, is controlled here in accordance with field-oriented control, that is to say vector control, by the assigned control unit 22, 32.

Furthermore, in this exemplary embodiment, provision is made for the DC bus 40 to also be of redundant design and to have a DC A-side and a DC B-side, wherein the DC B-side takes over a voltage supply in the event of a failure of the DC A-side. Tolerances with regard to a deviation between the actual voltage level and the target voltage level are defined to be smaller in relation to the DC A-side than in relation to the DC B-side. For this reason, for deviations between the actual voltage level and the target voltage level for the DC A-side and the DC B-side, different predetermined values for triggering measures of feeding back an actual voltage level that has exceeded a target voltage level are stored. The triggering of measures when the actual voltage level of the DC bus 40 has exceeded the target voltage level of the DC bus 40 is described below by way of example for the DC A-side.

In this exemplary embodiment, provision is made for small exceedances of the target voltage level, in particular caused by electric currents of up to 10 A generated by the first electric motor 21 in a generator mode, to be decreased by a DC bus control unit 45 responsible for the energy management of the DC bus, and thus the actual voltage level is reduced to bring it closer to the target voltage level.

In addition, the second control unit 32 of the steering system monitors a present actual voltage level of the DC bus 40 with respect to an exceedance of a target voltage level of the DC bus 40 by a predetermined first value. In the event of a detected exceedance by the predetermined first value, the A-side of the second electric motor 31 is actuated by the second control unit 32 for a conversion of electrical energy in the A-side of the second electric motor 31 so as to decrease the actual voltage level back to the target voltage level in the DC bus 40. The predetermined first value may be, in particular, between 0.1 V and 10 V (V: volts), in particular depending on the voltage level applied to the DC bus 40. If the target voltage level on the DC bus 40 is, for example, 12 V, the predetermined first value may be, in particular, 2 V, so that the A-side of the second electric motor 31 is thus actuated accordingly at an actual voltage level of 14 V.

For the energetic conversion of generated electric currents that increase the actual voltage level, the d-vector of the rotor-referred d/q system for the A-side of the second electric motor 31 and thus the current I_d for the A-side of this electric motor 31 is adapted in such a way that the actual voltage level is decreased again to the target voltage level. In particular, for this purpose, provision may be made for the target voltage according to the target voltage level of the DC bus 40, in addition to the actual voltage according to the actual voltage level of the DC bus 40, to be applied to an input for a PI controller of the second control unit 32 when it is identified that the actual voltage level has exceeded the target voltage level by the predetermined first value. Taking into account the actual voltage and target voltage applied to the PI controller and voltages U_d and U_q presently applied to d-q voltage outputs of the PID controller and the currents I_d and I_q fed back as part of the vector control, a required adaptation of the current I_d is advantageously determined, and a correspondingly adapted current I_d is provided, this being required, on the one hand, so that the A-side of the second electric motor 31 can be operated according to a detected steering specification and, on the other hand, excess electrical energy in the A-side of the second electric motor 31 is converted to decrease the actual voltage level to the target voltage level.

Furthermore, the first control unit 21 on the DC bus 40 monitors an exceedance of the target voltage by the actual voltage by a predetermined second value. This predetermined second value is in this case greater than the predetermined first value, and can be stipulated, in particular, in a manner adapted to the respective system, in particular with a value between 1 V and 18 V. This monitoring is performed here independently of the monitoring by the second control unit 32. Since the stipulated first value is also exceeded at an actual voltage level exceeding the target voltage level by the specified second value or more, the A-side of the second electric motor 31 is actuated by the second control unit 32 as already described. In addition, however, the first electric motor 21 is now actuated by the first control unit in an analogous manner to support the reduction of the actual voltage level.

For example, provision may be made for the nominal voltage level to be 13.8 V. The first predetermined value in this example is 0.2 V and the second predetermined value is 2.2 V. If the actual voltage level is thus 14 V or more, the A-side of the second electric motor 31 is actuated for converting the electrical energy and decreasing the actual voltage level to the target voltage level. If the actual voltage level is 16 V or more, the first electric motor 21 is advantageously additionally actuated for the energetic conversion of generated electric currents that increase the actual voltage level, in particular until the actual voltage level has fallen below 16 V again. If the actual voltage level has fallen further below 14 V, the actuation of the A-side of the second electric motor 31 for “burning off” the excess energy also advantageously ends.

In addition, provision is optionally made for the second control unit 32 that is assigned to the B-side of the second electric motor 31 on the DC bus 40 to monitor an exceedance of the target voltage by the actual voltage by a predetermined third value, wherein this predetermined third value is greater than the predetermined second value. This third value may be stipulated, in particular, with a value between 10 V and 20 V. This monitoring is carried out independently of the monitoring of the first value by the second control unit 32 assigned to the A-side of the second electric motor 31 and independently of the monitoring of the second value by the first control unit 22 assigned to the first electric motor 21. At an actual voltage level that exceeds the target voltage level at least by the stipulated third value, the A-side of the second electric motor 31, the first electric motor 21 and the B-side of the second electric motor are thus operated with an adapted value for the current I_d in order to reduce the actual voltage level and bring it back to the target voltage level. Different actuations of the electric motors 21, 31 that are associated with the respective actual voltage levels are thus carried out for different actual voltage levels that exceed the target voltage level. The actual voltage level is detected by the control units 22, 32 in real time, wherein the detection is synchronized between the control units 22, 32.

The exemplary embodiments illustrated in the figures and explained in conjunction therewith serve to explain the invention and have no limiting effect thereon. LIST OF REFERENCE SIGNS
1 Steering system
2 First actuator
21 First electric motor
22 First control unit
3 Second actuator
31 Second electric motor
32 Second control unit
4 Steering shaft
5 Steering handle
6 Steering gear
61 Coupling rod (rack)
62 Spindle drive
63 Transmission belt
8 Steerable wheel
9 Track rod
10 Signal line
40 DC bus
45 DC bus control unit
50 DC/DC converter

1. A method for operating an electromechanical steering system in a motor vehicle, wherein the steering system includes at least one actuator having at least one electric motor, wherein the at least one electric motor is connected via a DC bus to an electrical on-board power supply system of the motor vehicle, the method comprising:
operating the at least one electric motor in a motor mode or a generator mode depending on a driving situation;
wherein at least one control unit of the steering system monitors an actual voltage level of the DC bus with respect to an exceedance of a target voltage level of the DC bus by a predetermined value;
wherein, in the case of a detected exceedance by a first predetermined value, the actual voltage level is reduced by converting electrical energy in at least one of the electric motors.

2. The method according to claim 1, wherein different actuations of the at least one electric motor that are associated with the respective actual voltage levels are carried out for different actual voltage levels that exceed the target voltage level.

3. The method according to claim 1, wherein, in the event of a detected exceedance of the target voltage level up to a second value, wherein the second value is lower than the first value, a DC bus control unit associated with the DC bus controls a reduction of the actual voltage level.

4. The method according to claim 1, wherein the DC bus is of redundant design and has a DC A-side and a DC B-side, wherein the DC B-side takes over a voltage supply in the event of a failure of the DC A-side, wherein tolerances regarding a deviation between the actual voltage level and the target voltage level in relation to the DC A-side are lower than in relation to the DC B-side, and wherein different predetermined values for triggering the conversion of electrical energy in the at least one electric motor are defined for deviations between the actual voltage level and the target voltage level for the DC A-side and the DC B-side.

5. The method according to claim 1, wherein the steering system comprises a plurality of actuators, wherein each actuator is assigned a respective control unit, wherein each of these control units monitors the actual voltage level of the DC bus with respect to an exceedance of the target voltage level of the DC bus by a predetermined value, wherein a different deviation between the actual voltage level and the target voltage level is specified for each of the control units, said different deviation triggering an actuation to reduce the actual voltage level.

6. The method according to claim 1, wherein the at least one electric motor is controlled by a control unit by vector control, wherein a d-vector having an associated current I_d and a q-vector having an associated current I_q of a rotor-referred d/q system for the at least one electric motor are influenced by a first controller of the control unit, wherein the d-vector of the rotor-referred d/q system for the at least one electric motor is adapted for the conversion of electrical energy.

7. The method according to claim 1, wherein the steering system comprises, as the at least one actuator having the at least one electric motor, a feedback actuator acting via a steering shaft on a steering handle and having a first electric motor and a steering actuator acting via a steering gear on steerable wheels of the motor vehicle and having a second electric motor.

8. The method according to claim 7, wherein, in the case of the detected exceedance by at least the predetermined first value, the actual voltage level is reduced by converting electrical energy in the second electric motor.

9. The method according to claim 7, wherein the second electric motor of the steering actuator is of redundant design and has a separately actuatable A-side and a separately actuatable B-side, wherein, in the case of the detected exceedance by at least the predetermined first value, the actual voltage level is reduced by converting electrical energy on the A-side of the second electric motor.

10. The method according to claim 9, wherein, in the case of the detected exceedance by at least a predetermined third value, wherein the third value is greater than the first value, the actual voltage level is reduced by converting electrical energy on the B-side of the second electric motor.

11. The method according to claim 7, wherein, in the case of a detected exceedance by at least a predetermined second value, wherein the second value is greater than the first value, the actual voltage level is reduced by additionally converting electrical energy in the first electric motor.

12. An electromechanical steering system, comprising:
at least one actuator having at least one electric motor and at least one control unit;
wherein the at least one electric motor can be operated in a motor mode or a generator mode depending on a driving situation;
wherein the steering system is designed to be operated according to the method of claim 1.

13. The steering system according to claim 12, wherein the steering system is a steer-by-wire steering system.
